(19) United States
(12) Patent Application Publication
(10) Pub. No.: US 2016/0065803 A1
(43) Pub. Date: Mar. 3, 2016

(54) Television Display Device

(71) Applicants: Meco Williams, Tulsa, OK (US); Kaila Armstrong, Tulsa, OK (US); Shakyera Armstrong, Tulsa, OK (US)

(72) Inventors: Meco Williams, Tulsa, OK (US); Kaila Armstrong, Tulsa, OK (US); Shakyera Armstrong, Tulsa, OK (US)

(21) Appl. No.: 14/843,134

(22) Filed: Sep. 2, 2015

Related U.S. Application Data
(60) Provisional application No. 62/044,638, filed on Sep. 2, 2014.

(51) Int. Cl. H04N 5/225

(52) U.S. Cl. CPC H04N 5/2252

(57) ABSTRACT

A television display device for covering and decorating the borders of a television. The device includes a rear panel having one or more sidewalls, wherein the panel can be disposed on a wall, behind a television. The device further includes a frame that can be disposed over a television and removably attached to the rear panel by fasteners disposed on one or more sidewalls of the frame. The sidewalls of the frame are used to cover the borders of the television, wherein the panel can conceal a television wall mount and accompanying wires. The device can protect the exterior of a television and provide surface area suitable for advertisements, logos, and various designs. The fastener allows a user to conveniently interchange one frame for another.

### CROSS REFERENCE TO RELATED APPLICATION

This application claims the benefit of U.S. Provisional Application No. 62/044,638 filed on Sep. 2, 2014. The above identified patent application is herein incorporated by reference in its entirety to provide continuity of disclosure.

### BACKGROUND OF THE INVENTION

### Field of the Invention

The present invention relates to television display devices. More specifically, the present invention provides a television display device comprising a panel having one or more sidewalls and an exterior surface, wherein the panel can be disposed on a wall, behind a television. The exterior surface of the panel includes one or more apertures adapted to allow a television wall mount and accompanying wires to pass therethrough. The sidewalls of the panel include one or more grooves adapted to allow wires to pass therethrough. The device further includes a frame having one or more sidewalls. The sidewalls of the frame comprise one or more apertures adapted to provide access to television controls or speakers. The frame can be disposed over the television and removably attached to the panel by one or more fasteners.

The border around a flat-screen television typically has a simple, black or silver color and provides no customization. The color of a television border can clash with the design of the surrounding area. The mount used to attach a television to a wall can also be unattractive and visible from various angles. Additionally, flat screen televisions are expensive and can become damaged depending on where a user chooses to display his or her television. Therefore, there is a need in the prior art for a means to decorate the border of a television to fit a user's personal taste, conceal mounts and wires, and provide additional protection for a television.

Devices have been disclosed in the prior art that relate to television display devices. These include devices that have been patented and published in patent application publications. These devices generally relate to concealing a television with a frame to display a mirror or a picture in front of the television when it is not in use. Such devices include U.S. Pat. No. 8,134,651 to Reid and U.S. Published Patent Application Number 2007/0046841 to Jacobsmeyer and Lopez. These devices, however, fail to disclose a device that comprises a frame adapted to cover the border of a television screen while the television screen remains visible, whereby the frame can be removably attached to a panel by one or more magnetic fasteners.

Other devices generally relate to adding a decorative border behind a television or directly attached to a computer screen border. Such devices include U.S. Pat. No. 8,375,648 to O'Sullivan and U.S. Pat. No. 6,550,172 to Korpai. These devices, however, fail to disclose a device that comprises a frame disposed over a television and removably attached to a panel by one or more magnetic fasteners. Furthermore, these devices fail to comprise a frame and panel adapted to cover the sides, top, and bottom portions of a television thereby leaving much of the television visible, undecorated, and unprotected.

U.S. Published Patent Application Number 2007/0056201 to Price and Walsey provides a device that uses magnets to attach a picture to a frame that borders a television in order to conceal the television. This device, however, fails to disclose a device that comprises a frame adapted to cover a television border while the television screen remains visible, wherein the frame is removably attached by magnets to a panel.

In light of the devices disclosed in the prior art, it is submitted that the present invention substantially diverges in design elements from the prior art and consequently it is clear that there is a need in the art for an improvement to existing television display devices. In this regard the instant invention substantially fulfills these needs.

### SUMMARY OF THE INVENTION

In view of the foregoing disadvantages inherent in the known types of television display devices now present in the prior art, the present invention provides a new television display device wherein the same can be utilized for providing convenience for the user when covering and decorating the borders of a television.

It is therefore an object of the present invention to provide a new and improved television display device that has all of the advantages of the prior art and none of the disadvantages.

It is another object of the present invention to provide a television display device that encloses a television between a frame and a panel, thereby allowing the user to view only the screen portion of the television.

Another object of the present invention is to provide a television display device having a frame covering the border of a television, wherein the frame is removably attached to a panel adapted to conceal a television wall mount and accompanying wires.

Yet another object of the present invention is to provide a television viewing device wherein the frame is removably attached to the panel by one or more fasteners.

Yet another object of the present invention is to provide a television viewing device having interchangeable frame and panel members adapted to provide a customized appearance.

Another object of the present invention is to provide a television display device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the television display device.

FIG. 2A shows a perspective view of the frame of the television display device.

FIG. 2B shows a rear perspective view of the frame of the television display device.

FIG. 3A shows a perspective view of the panel of the television display device.

FIG. 3B shows a rear perspective view of the panel of the television display device.

FIG. 4 shows a perspective view of an embodiment of the television display device in use.

### DETAILED DESCRIPTION OF THE INVENTION

Reference is made herein to the attached drawings. Like reference numerals are used throughout the drawings to depict like or similar elements of the television display device. For the purposes of presenting a brief and clear description of the present invention, the preferred embodiment will be discussed as used for displaying a flat screen television mounted on a wall. The figures are intended for representative purposes only and should not be considered to be limiting in any respect.

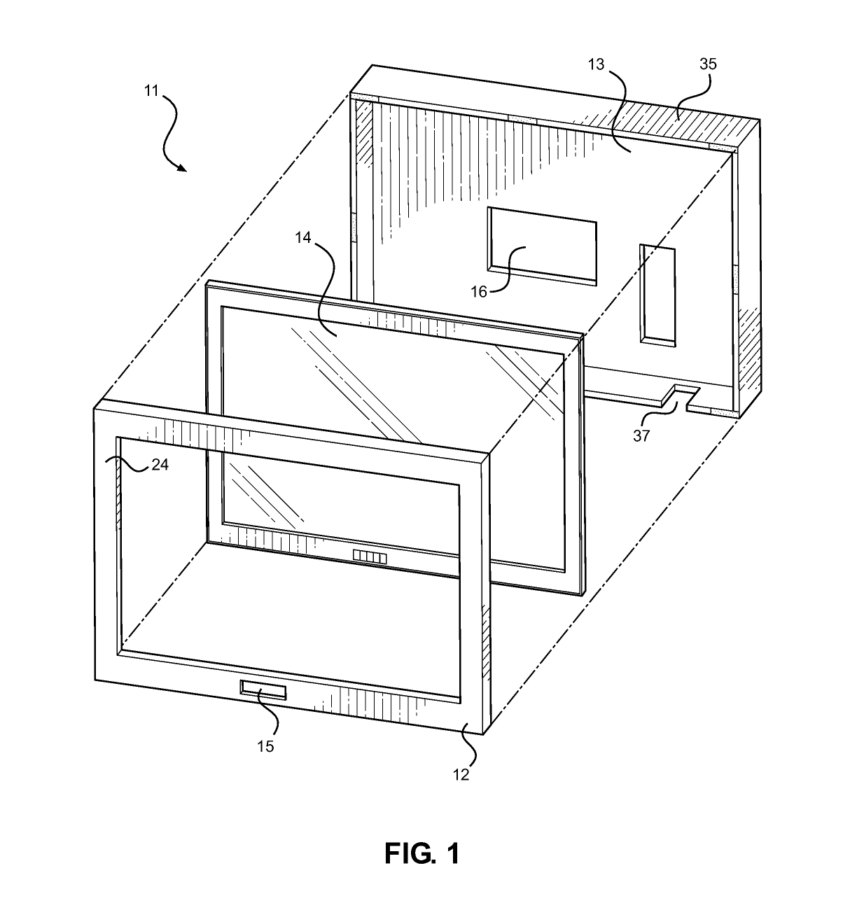

Referring now to FIG. 1, there is shown an exploded view of an embodiment of the television display device. The television display device 11 comprises a frame 12 having one or more sidewalls 24. The device 11 further includes a panel 13 having one or more sidewalls 35 and an exterior surface, wherein one or more apertures 16 are included therein. The sidewalls 35 of the panel 13 include one or more grooves 37 adapted to allow wires to pass therethrough. When in use, a television 14 is placed between the frame 12 and the panel 13, wherein the frame 12 is removably secured to the panel 13 by one or more fasteners. A fastener includes a first member adapted to removably attach to a second member.

The frame 12 and panel 13 are adapted to provide a customized appearance, allowing a user to select the color, pattern, or design. The frame 12 can be removably attached to the panel 13 by fasteners, thereby allowing a user to interchange a variety of frames 12 having various advertisements, logos, and designs. The panel allows for additional space to decorate as a user desires.

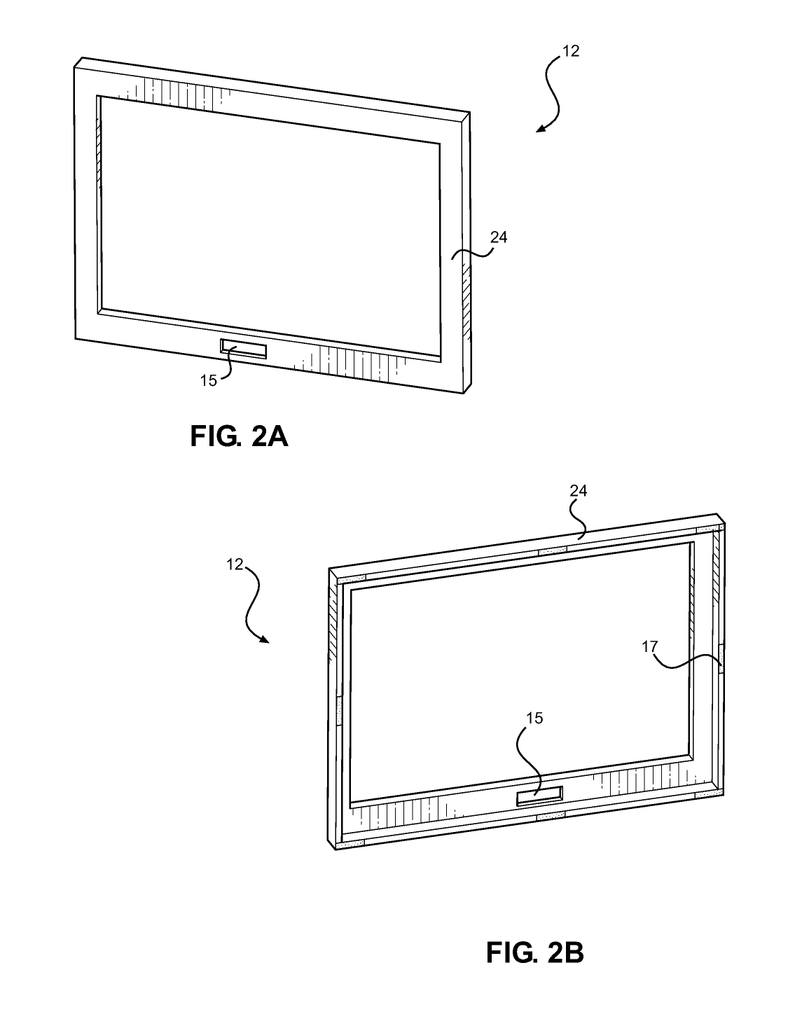

Referring now to FIGS. 2A and 2B, there is shown a perspective view and a rear perspective view the frame. The frame 12 is preferably substantially rectangular in configuration so to match the shape of the television. The sidewalls 24 of the frame 12 are adapted to conceal the borders of the television. The depth of the sidewall 24 is preferably the same or larger than the depth of the television so the frame 12 can cover the top, sides and bottom of the television.

There are one or more apertures 15 included in the sidewall 24 to provide access to the television controls or speakers. The apertures 15 can be configured to match the configuration of the television controls or speakers. When the frame 12 is placed over the television, the apertures 15 can be flush with the controls or speakers of the television.

A first member 17 of the fastener can be disposed on the edge of a sidewall 24, wherein the first member is adapted to removably secure the frame 12 to the panel. The first member 17 can be any suitable configuration, such as a circle or rectangle, so long as the first member 17 aligns with the corresponding second member disposed on the panel. The first members 17 of the fasteners are preferably spaced at fixed intervals so to uniformly distribute the weight of the frame 12 on the panel. The height and width of the edge of the sidewall 24 is preferably substantially identical to the height and width of the first member 17, respectively, so the sidewall 24 does not have more surface area than necessary to support the first member 17. The preferred fasteners are magnets, but can be any suitable fastener, such as loop and hook material or snaps. In some embodiments, the frame 12 can be any dimension larger than the television so to provide the maximum desired frame surface area for advertisements or decoration.

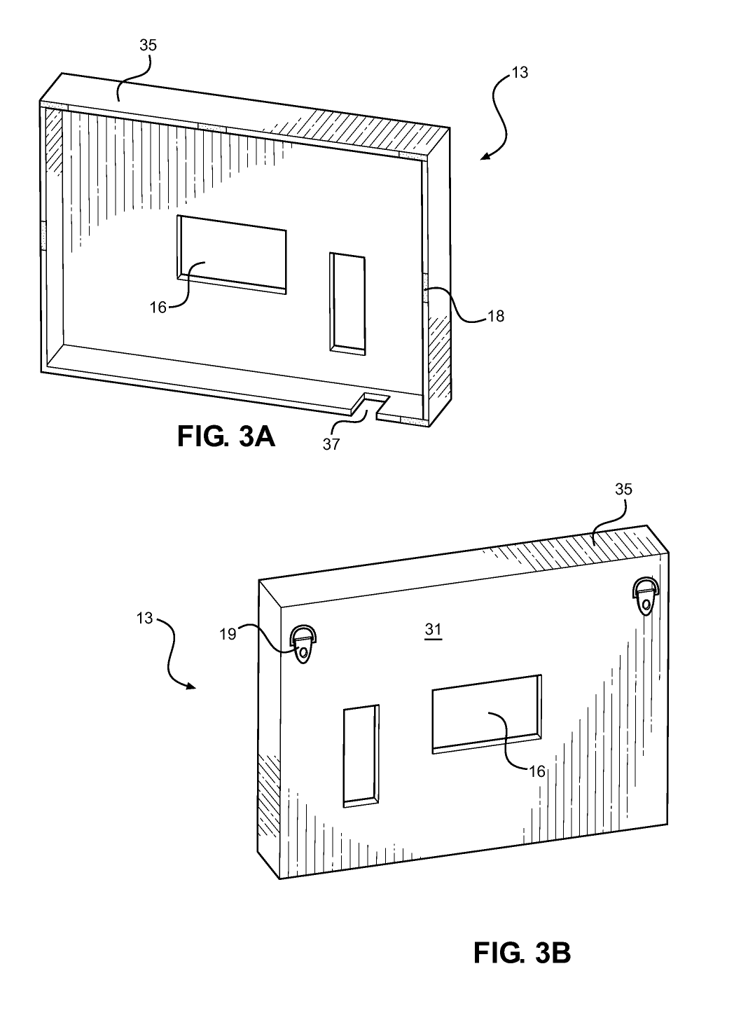

Referring now to FIGS. 3A and 3B, there is shown a perspective view and a rear perspective view of the panel. The panel 13 is preferably substantially rectangular in configuration. The perimeter of the panel 13 is preferably substantially identical to the perimeter of the frame so when the panel 13 is removably attached thereto, the edge of the sidewalls of the frame will be flush with the edge of the sidewalls 35 of the panel 13. The depth of the sidewalls 35 of the panel 13 is preferably substantially similar to the depth of a mount the user uses to attach the television to the wall. In this way, the panel 13 is able to conceal a wall mount. The exterior surface 31 of the panel 13 comprises one or more apertures 16 adapted to allow a television wall mount and accompanying wires to pass therethrough. Preferably, there is an aperture 16 disposed on the center of the exterior surface 31 so to fit a wall mount therethrough. One or more grooves 37 are preferably disposed on one or more sidewalls 35 to pass additional wires therethrough.

The panel 13 further comprises one or more second members 18 of the fastener adapted to receive the first member disposed on the edge of the sidewalls of the frame. Preferably, the second member 18 is composed of ferromagnetic material adapted to receive a magnet disposed on the frame. The second member 18 is preferably spaced at fixed intervals along the edge of the sidewall 35 of the panel. The second member 18 can be circular, rectangular, or any other configuration so long as the second member 18 aligns with the first member disposed on the frame. The fasteners can be secured to the panel 13 and frame by any suitable material, such as adhesive. In some embodiments, the second member 18 can be disposed on the frame and the first member can be disposed on the panel 13.

The exterior surface 31 of the panel can be permanently attached to a support surface by any suitable fastener, such as hangers 19 or screws. The fasteners are preferably disposed on the upper end of the exterior surface 31 so to support the weight of the device.

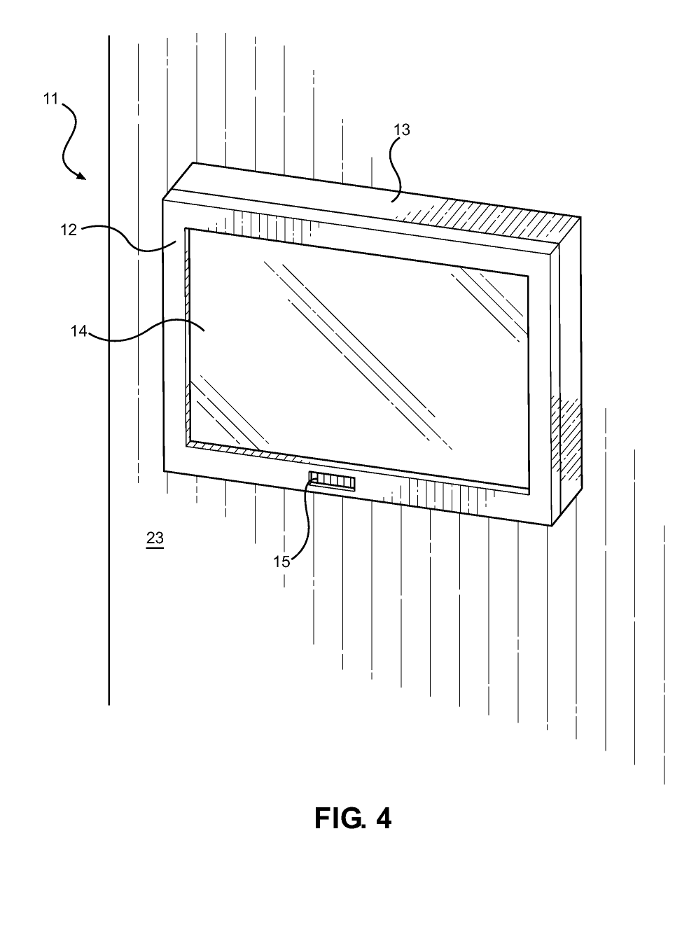

Referring now to FIG. 4, there is shown a perspective view of an embodiment of the television display device in use. In operation, the user can permanently fasten the panel 13 to a wall 23 so the exterior surface rests flush against the wall 23. Next, the user can install a television wall mount through an aperture disposed on the exterior surface of the panel 13. The user can then mount a television to the television mount and removably attach the frame 12 by aligning the first members disposed on the edge of the sidewalls 24 of the frame 12 with the second members disposed on the edge of the sidewalls 35 of the panel 13. The television controls can be accessible via an aperture 15 disposed on the sidewall 24 of the frame 12. The user can enjoy his or her television 14 with the decorative cover that he or she desires.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1) A television display device, comprising:
a panel having one or more sidewalls extending therefrom and an exterior surface, wherein said exterior surface includes one or more fasteners adapted to permanently attach said panel to a support surface;
a frame having one or more sidewalls extending therefrom;
one or more fasteners adapted to removably attach said frame to said panel such that a television can be enclosed within said panel and said frame.

2) The television display device of claim 1, wherein said frame and said panel are preferably rectangular in configuration.

3) The television display device of claim 1, wherein said one or more sidewalls of said frame include one or more apertures adapted to provide access to one or more television controls or speakers.

4) The television display device of claim 1, wherein said exterior surface of said panel comprises one or more apertures adapted for disposing a television mount and wires therethrough.

5) The television display device of claim 1, wherein said one or more fasteners adapted to removably attach said frame to said panel are magnets.

6) The television display device of claim 1, wherein said one or more fasteners are spaced at a fixed interval.
